(19) United States
(12) Patent Application Publication
(10) Pub. No.: US 2013/0269491 A1
(43) Pub. Date: Oct. 17, 2013

(54) HAND TOOL WITH PIVOTABLE SHANK

(71) Applicant: Pi-Hsia CHANG, Taichung (TW)

(72) Inventor: Pi-Hsia CHANG, Taichung (TW)

(21) Appl. No.: 13/549,571

(22) Filed: Jul. 16, 2012

(30) Foreign Application Priority Data
Apr. 17, 2012 (TW) 101207094

(51) Int. Cl. B25B 23/16

(52) U.S. Cl. 81/177.8; 81/177.7

(57) ABSTRACT

A hand tool includes a tool head, a shank, a handle, a pivot pin and a locking mechanism. The shank has one end joined to the tool head and the other end pivotally mounted in the handle via the pivot pin. The pivot pin pivot pin has a series of axially parallel teeth formed therearound. The locking mechanism mounted on the shank and includes a brake rod, a spring sleeved on the brake rod and a push button slidingly mounted on the shank. The brake rod has a curved recess defined in a distal end surface thereof and a series of teeth formed at a bottom of the curved recess for selective mating engagement with the teeth of the pivot pin. The push button is provided for controlling axial reciprocal movement of the brake rod.

### BACKGROUND OF THE INVENTION

1. Field of the Invention

The present invention relates to a hand tool for driving fasteners, and more particularly to a hand tool having a pivotable shank.

2. Description of the Related Art

Conventionally, hand tools, such as socket wrenches or the like, are equipped with bits and sleeves in different sizes and shapes. With such tools, operators can effectively perform a variety of mechanical assembly tasks.

A typical hand tool includes a shank, a handle disposed in fixed axial alignment with the shank, and a distal tool head. The shank and the handle together are often long enough to apply sufficient torque to the tool head in order to obtain the force needed for effective operation of the tool. However, in the use of such axial handle whose position is fixed greatly limits the use of such tools in inaccessible or crowded locations.

U.S. Pat. No. 6,971,292 illustrates a hand tool having its fastener-driving member (or tool head) adjustable angularly to different positions with respect to a coupling device (or shank) and a handle joined with the shank. The tool head is pivotally attached to the shank by means of several parts having teeth thereon for engagement and positioning. Besides, the patent also suggests that more than one pivotable shank can be included and joined in a line with the handle to form a relatively longer hand tool, if necessary.

### SUMMARY OF THE INVENTION

The present invention provides an improved hand tool with different construction. In particular, the hand tool has its shank which can be easily adjusted to different angles with respect to its handle and securely held in a selected position.

The hand tool in accordance with the present invention comprises a tool head, a shank, a handle, a pivot pin and a locking mechanism. The shank has one end joined to the tool head and the other end pivotally mounted in the handle via the pivot pin. The locking mechanism is mounted on the shank to control the pivot movement of the shank.

Specifically, the shank defines at the other end an axial stepped bore and a transverse pin hole intersecting the axial stepped bore. The axial stepped bore of the shank has an inner section, an outer enlarged diameter section and a shoulder formed at the junction between the inner section and the outer enlarged diameter section. On the other hand, the handle has a receiving recess defined in an end surface and extending in an axial direction and being open to a peripheral thereof. The handle further has a pivot hole extending in a direction transverse to the axial direction and intersecting with the receiving recess. The pivot pin is securely received in the pivot hole of the handle and extends through the pin hole of the shank to pivotally mount the shank on the handle. Moreover, the pivot pin has a series of axially parallel teeth formed therearound.

The locking mechanism includes a brake rod, a spring and a push button. The brake rod is slidingly positioned in the axial stepped bore of the shank and has a small-diameter portion seated in the inner section of the axial stepped bore of the shank, a large-diameter portion seated in the outer enlarged diameter section of the axial stepped bore of the shank, and a shoulder formed at the junction between the small-diameter portion and the large-diameter portion. The large-diameter portion of the brake rod is smaller in length than outer enlarged diameter section of the axial stepped bore of the shank and has a curved recess defined in a distal end surface thereof and a series of teeth formed at a bottom of the curved recess for selective mating engagement with the teeth of the pivot pin. The spring is sleeved on the small-diameter portion of the brake rod and has one end resting against the shoulder of the brake rod and the other end resting against the shoulder of the shank. The push button is slidingly mounted on the shank, attached to the brake rod and exposed in the receiving recess of the handle for controlling axial reciprocal movement of the brake rod in the axial stepped bore of the shank.

As described above, the teeth engagement between the pivot pin and the brake rod ensures that when the shank is adjusted angularly to a desire position with respect to the handle, the shank is securely held in that position.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool in accordance with the preferred embodiment of the present invention;

FIG. 2 is an exploded perspective view of the hand tool shown in FIG. 1;

FIG. 3 is a front cross section of the hand tool shown in FIG. 1;

FIG. 4 is a side view of the hand tool shown in FIG. 1, showing that the shank is in a position in axial alignment with the handle;

FIG. 5 is a partial enlarged cross-sectional view of the hand tool shown in FIG. 2, showing that the shank is held in position in the handle;

FIG. 6 is a partial enlarged cross-sectional view of the hand tool shown in FIG. 5;

FIG. 7 is a view similar to FIG. 5, showing that the shank is allowed to pivot with respect to the handle; and

FIG. 8 is another side view of the hand tool, showing that the shank is pivoted to another position in vertical alignment with the handle.

### DETAILED DESCRIPTION OF PREFERRED EMBODIMENT

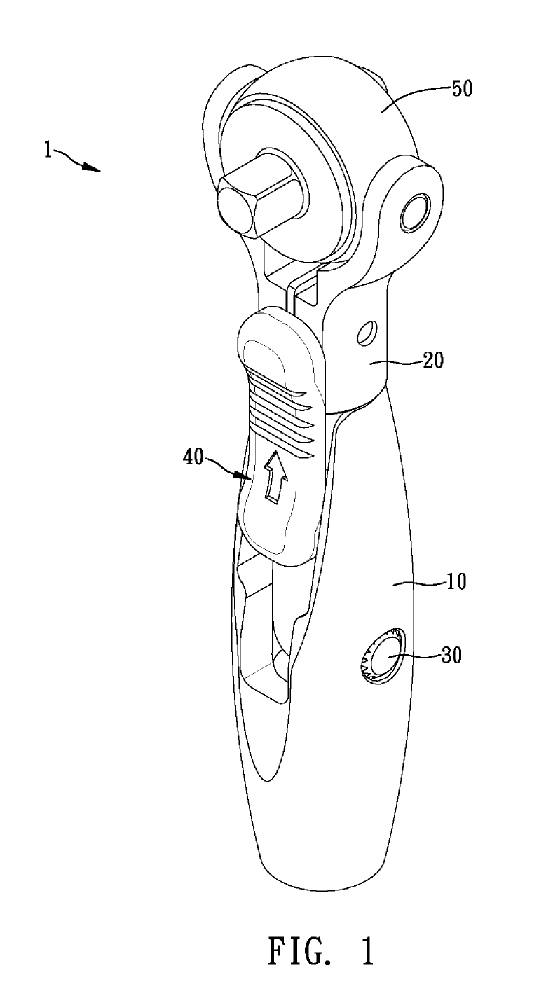

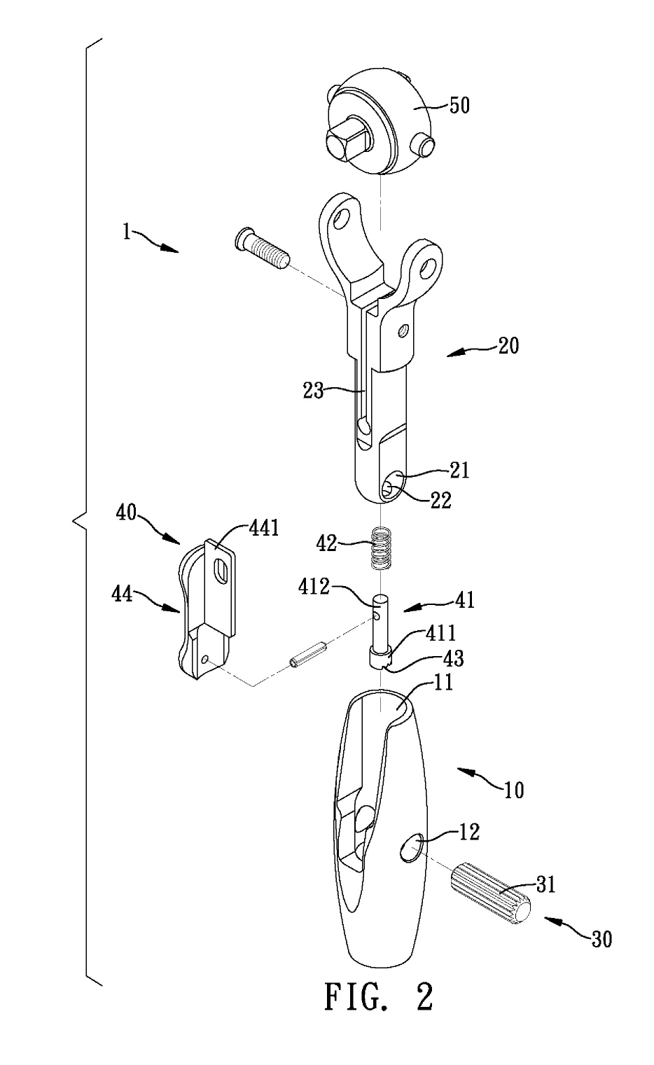

Referring to the drawings and initially to FIGS. 1-2, a hand tool 1 is provided in accordance with the preferred embodiment of the present invention. The hand tool 1 includes a handle 10, a shank 20 with one end pivotally mounted in the handle 10, a pivot pin 30 transversely extending through the handle 10 to pivotally mount the shank 20 on the handle 10, a locking mechanism 40 mounted on the shank 20 for controlling pivot movement of the shank 20, and a tool head 50 rotatably mounted on the other end of the shank 20. In this preferred embodiment, the tool head 50 has a ratcheting mechanism built-in and is adapted to couple with a socket (not shown), so that the hand tool 1 can be turned using a back-and-forth motion in cramped spaces.

As best seen in FIG. 2, the handle 10 has a receiving recess 11 defined in a top surface and extending in an axial direction and being open to a peripheral thereof. The handle 10 further defines a pivot hole 12 extending through a peripheral wall thereof in a direction transverse to the axial direction. The receiving recess 11 and the pivot hole 12 of the handle 10 intersect with each other.

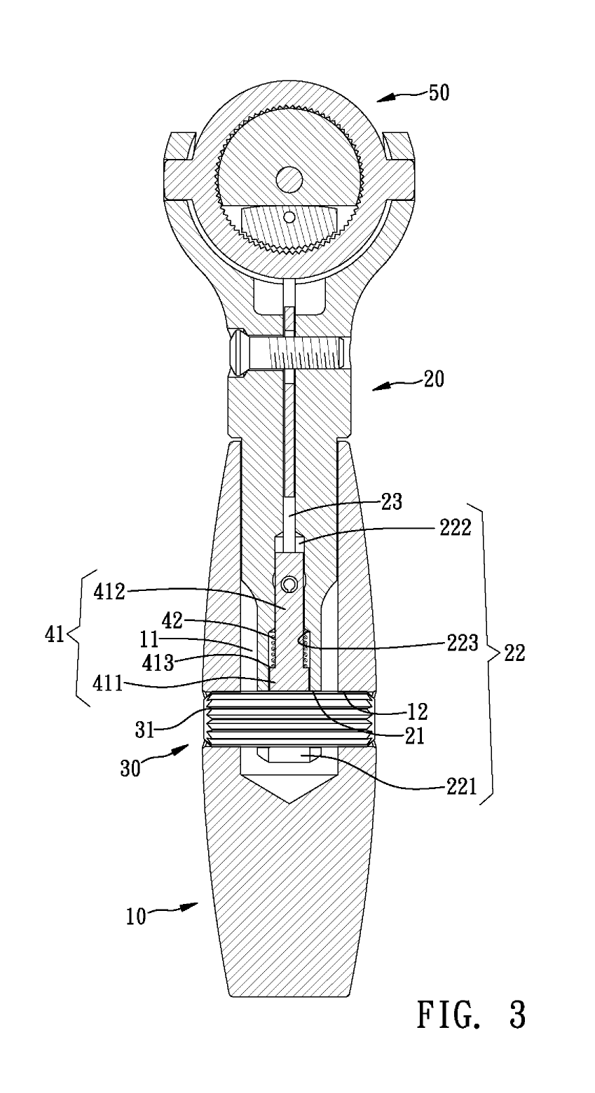

Referring to FIGS. 2 and 3, the shank 20 defines at one end a transverse pin hole 21 and an axial stepped bore 22 intersecting with the transverse pin hole 21, and at the other end an axial split groove 23 facing the tool head 50. The axial stepped bore 22 of the shank 20 has an inner section 222, an outer enlarged diameter section 221 and a shoulder 223 formed at the junction between the inner section 222 and the outer enlarged diameter section 221. The pin hole 21 of the shank 20 is slightly larger in diameter than the pivot hole 12 of the handle 10. The split groove 23 of the shank 20 extends to the inner section 222 of the axial stepped bore 22 of the shank 20 to facilitate installation of the tool head 50 onto the shank 20.

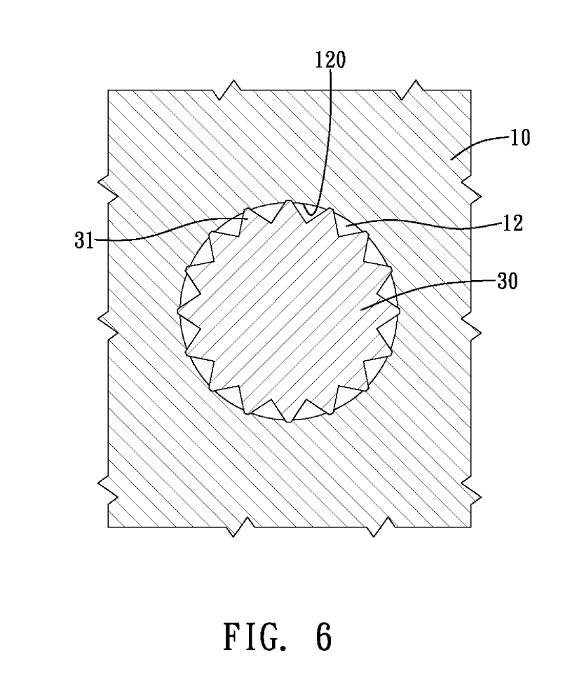

The pivot pin 30 is securely mounted in the pivot hole 12 of the handle 10 and extending through the pin hole 21 of the shank 20 to pivotally mount the shank 20 in the handle 10 and avoiding a brake rod 41 of the locking mechanism 40 from falling off. The pivot pin 30 has a series of axially parallel teeth 31 formed therearound and has a diameter slightly greater than that of the pivot hole 12 of the handle 10, as best seen in FIG. 6, such that the pivot pin 30 can be securely mounted in the pivot hole 12 of the handle 10 by means of the teeth 31 of the pivot pin 30 cutting into an inner wall surface 120 of the pivot hole 12 of the handle 10.

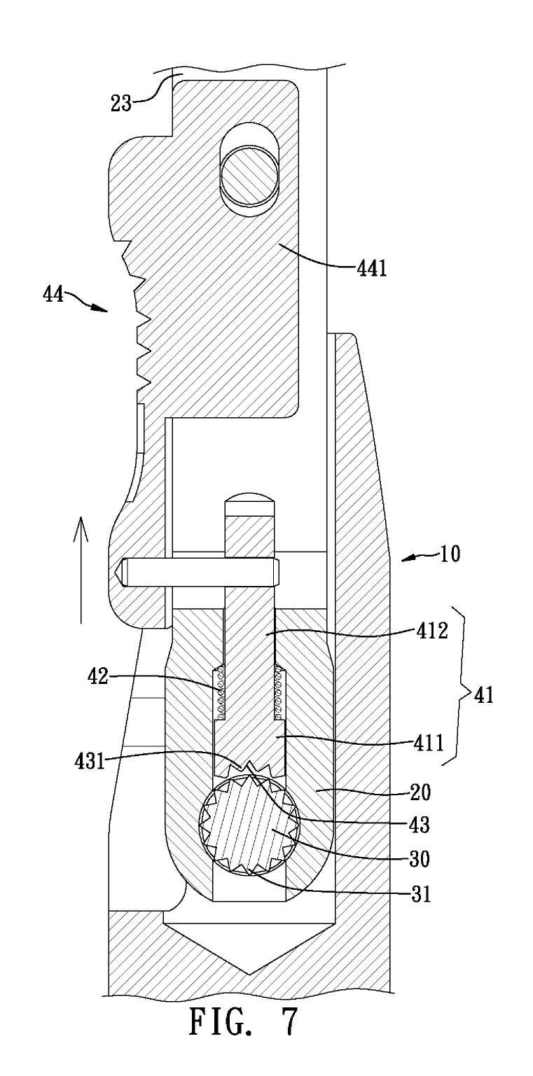

As shown in FIG. 2, the locking mechanism 40 includes the brake rod 41, a spring 42 and a push button 44. As shown in FIG. 3, the brake rod 41 is slidingly positioned in the axial stepped bore 22 of the shank 20. The broke rod 41 has a small-diameter portion 412 seated in the inner section 222 of the axial stepped bore 22 of the shank 20, a large-diameter portion 411 seated in the outer enlarged diameter section 221 of the axial stepped bore 22 of the shank 20, and a shoulder 413 formed at the junction between the small-diameter portion 412 and the large-diameter portion 411. It is noted that the large-diameter portion 411 of the brake rod 41 is smaller in length than outer enlarged diameter section 221 of the axial stepped bore 22 of the shank 20. As best seen in FIG. 7, the large-diameter portion 411 of the brake rod 41 has a curved recess 43 defined in a distal end surface thereof and a series of teeth 431 formed at a bottom of the curved recess 43 for selective mating engagement with the teeth 31 of the pivot pin 30.

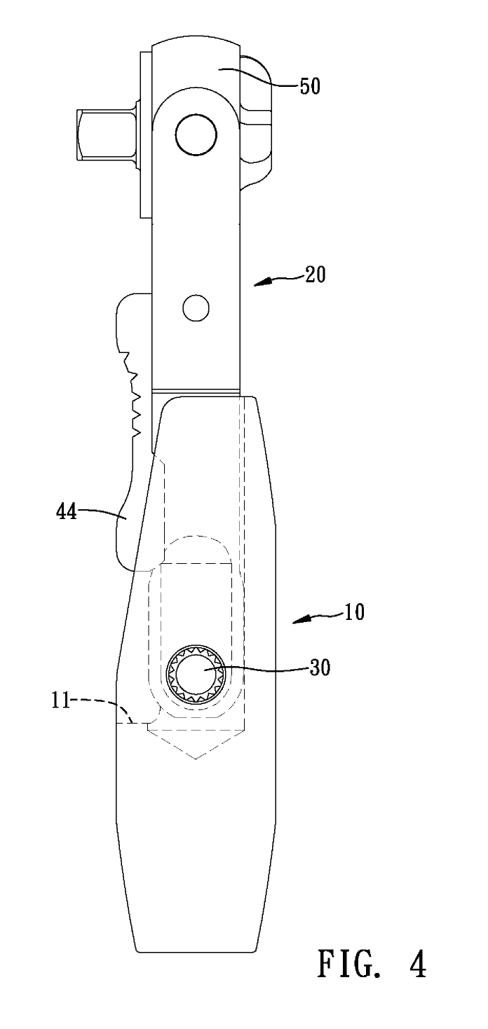

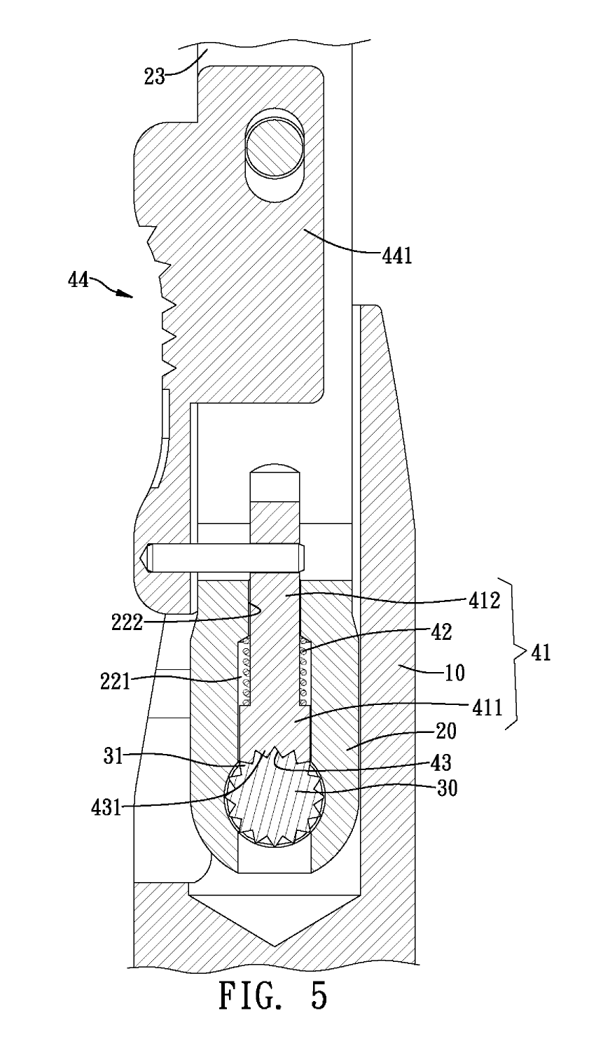

Referring back to FIG. 3, the spring 42 is sleeved on the small-diameter portion 412 of the brake rod 41 and has one end resting against the shoulder 413 of the brake rod 41 and the other end resting against the shoulder 223 of the shank 20. Referring to FIGS. 3 and 4, the push button 44 is slidingly mounted on the shank 20, attached to the brake rod 41 and partly exposed in the receiving recess 11 of the handle 10 for controlling axial reciprocal movement of the brake rod 41 in the axial stepped bore 22 of the shank 20. More specifically, the push button 44 is formed with a guiding plate 441, as shown in FIG. 1 or 5, slidably mounted in the split groove 23 of the shank 20.

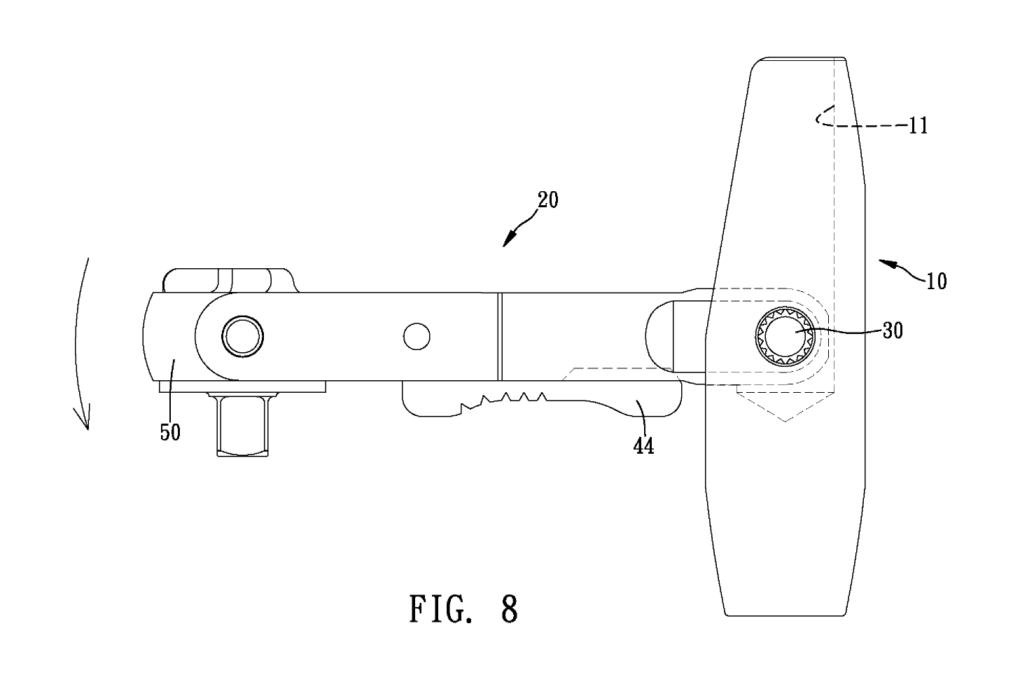

To operate the hand tool 1 in accordance with this preferred embodiment, starting with an operating position as shown in FIGS. 4 and 5, the shank 20 is disposed in axial alignment with the handle 10 and the teeth 431 of the brake rod 41 is engaged with the teeth 31 of the pivot pin 30, and therefore the shank 20 is not allowed to be pivoted with respect to the handle 10. At this time, the hand tool is ready for use, such as for screw fastening or loosening. On the contrary, when it is desired to have the shank 20 be pivoted with respect to the handle 10 to another position at different angle, a user can simply push the push button 44 along a side wall of the shank 20, by application of a little force, to drive the brake rod 41 to press against the spring 42 so as to have the teeth 431 of the brake rod 41 detached from the teeth 31 of the pivot pin 30, as shown in FIG. 7. At such time, the bush button is still held by the user, and the shank 20 is allowed to be pivoted. After the shank 20 is pivoted to a selected position, as shown in FIG. 8, releasing of the push button 44 will have the brake rod 41 return back to its original position as a result of the restored spring 42 and have the teeth 431 of the brake rod 41 re-engaged with the teeth 31 of the pivot pin 30. In other words, the teeth engagement between the pivot pin 30 and the brake rod 41 ensures that when the shank 20 is adjusted angularly to a desired position with respect to the handle 10, the shank 20 can be securely held in that position.

Although the invention has been explained in relation to its preferred embodiment(s), it is to be understood that many other possible modifications and variations can be made without departing from the spirit and scope of the invention as hereinafter claimed.

What is claimed is:

1. A hand tool comprising:
a tool head;
a shank with one end joined to the tool head and the other end defining an axial stepped bore and a transverse pin hole intersecting the axial stepped bore; the axial stepped bore having an inner section, an outer enlarged diameter section and a shoulder formed at the junction between the inner section and the outer enlarged diameter section;
a handle having a receiving recess defined in an end surface and extending in an axial direction and being open to a peripheral thereof, and a pivot hole extending in a direction transverse to the axial direction and intersecting with the receiving recess;
a pivot pin securely received in the pivot hole of the handle and extending through the pin hole of the shank to pivotally mount the shank in the handle; and the pivot pin has a series of axially parallel teeth formed therearound; and
a locking mechanism mounted on the shank and including:
(1) a brake rod slidingly positioned in the axial stepped bore of the shank and having a small-diameter portion seated in the inner section of the axial stepped bore of the shank, a large-diameter portion seated in the outer enlarged diameter section of the axial stepped bore of the shank, and a shoulder formed at the junction between the small-diameter portion and the large-diameter portion, wherein the large-diameter portion of the brake rod is smaller in length than outer enlarged diameter section of the axial stepped bore of the shank and has a curved recess defined in a distal end surface thereof and a series of teeth formed at a bottom of the curved recess for selective mating engagement with the teeth of the pivot pin;
(2) a spring sleeved on the small-diameter portion of the brake rod and having one end resting against the shoulder of the brake rod and the other end resting against the shoulder of the shank; and
(3) a push button slidingly mounted on the shank, attached to the brake rod and exposed in the receiving recess of the handle for controlling axial reciprocal movement of the brake rod in the axial stepped bore of the shank.

2. The hand tool of claim 1, wherein the pivot pin with a diameter slightly greater than that of the pivot hole of the handle is securely mounted in the pivot hole of the handle by means of the teeth of the pivot pin cutting into an inner wall surface of the pivot hole of the handle.

3. The hand tool of claim 2, wherein the shank further defines an axial split groove at the end facing the tool head, and the split groove extends to the inner section of the axial stepped bore of the shank.

4. The hand tool of claim 3, wherein the push button is formed with a guiding plate slidably mounted in the split groove of the shank.

5. The hand tool of claim 4, wherein the tool head is rotatably joined to the shank.

6. The hand tool of claim 1, wherein the shank further defines an axial split groove at the end facing the tool head, and the split groove extends to the inner section of the axial stepped bore of the shank.

7. The hand tool of claim 1, wherein the push button is formed with a guiding plate slidably mounted in the split groove of the shank.

8. The hand tool of claim 1, wherein the tool head is rotatably joined to the shank.
